(19) United States
(12) Patent Application Publication
(10) Pub. No.: US 2024/0178467 A1
(43) Pub. Date: May 30, 2024

(54) BATTERY PACK AND VEHICLE

(71) Applicant: MURATA MANUFACTURING CO., LTD., Kyoto (JP)

(72) Inventor: Atsushi CHINEN, Kyoto (JP)

(21) Appl. No.: 18/436,183

(22) Filed: Feb. 8, 2024

Related U.S. Application Data
(63) Continuation of application No. PCT/JP2022/026250, filed on Jun. 30, 2022.

(30) Foreign Application Priority Data
Sep. 22, 2021 (JP) 2021-154174

(51) Int. Cl. H01M 10/44; B60L 50/60; B60L 50/64; H01M 10/42

(52) U.S. Cl. CPC H01M 10/441; B60L 50/64; B60L 50/66; H01M 10/425; H01M 2220/20

(57) ABSTRACT

A battery pack is provided and includes a secondary battery, a positive terminal and a negative terminal that are connected to the secondary battery, a control circuit that includes a power supply terminal and is capable of monitoring the secondary battery, a charging terminal guided to the power supply terminal of the control circuit, and a current limiting element provided in a current path connecting a first terminal, which is one of the positive terminal and the negative terminal, and the charging terminal.

### CROSS REFERENCE TO RELATED APPLICATIONS

The present application is a continuation of PCT patent application no. PCT/JP2022/026250, filed on Jun. 30, 2022, which claims priority to Japanese patent application no. 2021-154174, filed on Sep. 22, 2021, the entire contents of which are incorporated herein by reference.

### BACKGROUND

The present disclosure relates to a battery pack including a secondary battery, and a vehicle including a battery pack.

A vehicle is generally equipped with an auxiliary battery that supplies power to an engine starter, various accessories, and the like. For example, A technique of charging an auxiliary battery by using an external power supply is disclosed in a case where battery voltage of the auxiliary battery is low and an engine cannot be started.

### SUMMARY

The present disclosure relates to a battery pack including a secondary battery, and a vehicle including such a battery pack.

In a battery pack including a rechargeable battery, it is desired to monitor a state of the rechargeable battery, and it is expected to more reliably monitor a state of the rechargeable battery.

It is desirable to provide a vehicle and a battery pack that can more reliably monitor a state of a rechargeable battery.

A battery pack according to an embodiment of the present disclosure includes a secondary battery, a positive terminal and a negative terminal, a control circuit, a charging terminal, and a current limiting element. The positive terminal and the negative terminal are connected to the secondary battery. The control circuit has a power supply terminal and can monitor the secondary battery. The charging terminal is guided to the power supply terminal of the control circuit. The current limiting element is provided in a current path connecting the first terminal, which is one of the positive terminal and the negative terminal, and the charging terminal.

A vehicle according to an embodiment of the present disclosure includes a driving force generation unit, a drive control unit, and a battery pack. The driving force generation unit can generate a driving force. The drive control unit can control operation of the driving force generation unit. The battery pack can supply power to the drive control unit. The battery pack includes a secondary battery, a positive terminal and a negative terminal, a control circuit, a charging terminal, and a current limiting element. The positive terminal and the negative terminal are connected to the secondary battery. The control circuit has a power supply terminal and can monitor the secondary battery. The charging terminal is guided to the power supply terminal of the control circuit. The current limiting element is provided in a current path connecting the first terminal, which is one of the positive terminal and the negative terminal, and the charging terminal.

According to the battery pack and the vehicle in an embodiment of the present disclosure, a state of a rechargeable battery can be more reliably monitored.

### BRIEF DESCRIPTION OF THE FIGURES

FIG. 1 is a circuit diagram illustrating a configuration example of a vehicle including a battery pack according to an embodiment of the present disclosure.

FIG. 2 is an explanatory diagram illustrating an example of a characteristic of a battery cell illustrated in FIG. 1.

FIG. 3 is an external configuration diagram illustrating a configuration example of the battery pack illustrated in FIG. 1.

FIG. 4 is an explanatory diagram illustrating an operation example of the vehicle illustrated in FIG. 1.

FIG. 5 is an explanatory diagram illustrating another operation example of the vehicle illustrated in FIG. 1.

FIG. 6 is an explanatory diagram illustrating an operation example of preliminary charging in the battery pack illustrated in FIG. 1.

FIG. 7 is an explanatory diagram illustrating another operation example of preliminary charging in the battery pack illustrated in FIG. 1.

FIG. 8 is an explanatory diagram illustrating another operation example of preliminary charging in the battery pack illustrated in FIG. 1.

FIG. 9 is an explanatory diagram illustrating an operation example of preliminary charging in a battery pack according to a comparative example.

FIG. 10 is an explanatory diagram illustrating another operation example of preliminary charging in a battery pack according to a comparative example.

FIG. 11 is an explanatory diagram illustrating another operation example of preliminary charging in a battery pack according to a comparative example.

FIG. 12 is an explanatory diagram illustrating another operation example of preliminary charging in a battery pack according to a comparative example.

FIG. 13A is a flowchart illustrating an operation example of preliminary charging in the battery pack illustrated in FIG. 1.

FIG. 13B is a flowchart illustrating an operation example of preliminary charging in the battery pack illustrated in FIG. 1.

FIG. 14 is a circuit diagram illustrating a configuration example of the battery pack according to a variation.

FIG. 15 is a circuit diagram illustrating a configuration example of the battery pack according to another variation.

FIG. 16 is a circuit diagram illustrating a configuration example of the battery pack according to another variation.

FIG. 17 is a circuit diagram illustrating a configuration example of the battery pack according to another variation.

FIG. 18 is a circuit diagram illustrating a configuration example of the battery pack according to another variation.

FIG. 19 is a block diagram illustrating a configuration example of a vehicle according to an application example.

FIG. 20 is a circuit diagram illustrating a configuration example of the battery pack according to another variation.

### DETAILED DESCRIPTION

The present disclosure will be described in further detail below including with reference to the drawings according to an embodiment.

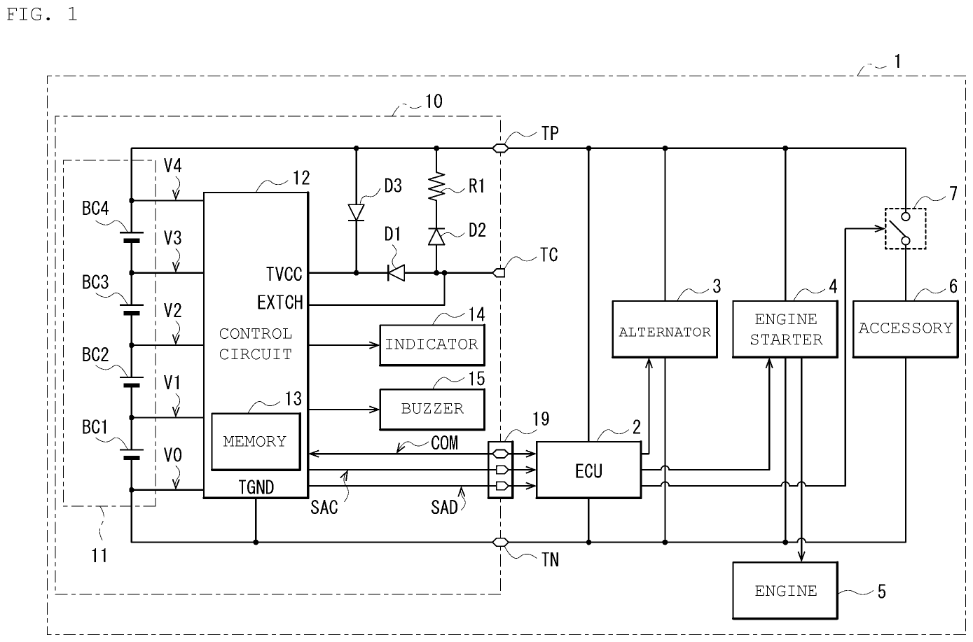

FIG. 1 illustrates a configuration example of a vehicle 1 including a battery pack according to an embodiment. The vehicle 1 is configured to travel on the basis of a driving force generated by an engine. The vehicle 1 includes a battery pack 10, an electronic control unit (ECU) 2, an alternator 3, an engine starter 4, an engine 5, an accessory 6, and a switch 7.

The battery pack 10 is configured to store power and functions as an auxiliary battery in the vehicle 1. The battery pack 10 includes a positive terminal TP, a negative terminal TN, a charging terminal TC, a connector 19, a secondary battery 11, a control circuit 12, diodes D1, D2, and D3, a resistive element R1, an indicator 14, and a buzzer 15.

The positive terminal TP and the negative terminal TN are configured to exchange power between the battery pack 10 and the outside of the battery pack 10. The charging terminal TC is configured to connect a charger and an external battery, for example, in a case where battery voltage of the battery pack 10 is low and the engine starter 4 cannot start the engine 5. The connector 19 is configured to exchange a signal between the ECU 2 and the battery pack 10.

The secondary battery 11 includes a plurality of battery cells BC (in this example, four of the battery cells BC1 to BC4). Each of the battery cells BC1 to BC4 is configured using a lithium ion secondary battery in this example. The battery cells BC1 to BC4 are connected in series. Specifically, a positive electrode of the battery cell BC1 is connected to a negative electrode of the battery cell BC2, and a negative electrode is connected to the negative terminal TN of the battery pack 10. A positive electrode of the battery cell BC2 is connected to a negative electrode of the battery cell BC3, and the negative electrode is connected to the positive electrode of the battery cell BC1. A positive electrode of the battery cell BC3 is connected to a negative electrode of the battery cell BC4, and the negative electrode is connected to the positive electrode of the battery cell BC2. A positive electrode of the battery cell BC4 is connected to the positive terminal TP of the battery pack 10, and the negative electrode is connected to the positive electrode of the battery cell BC3.

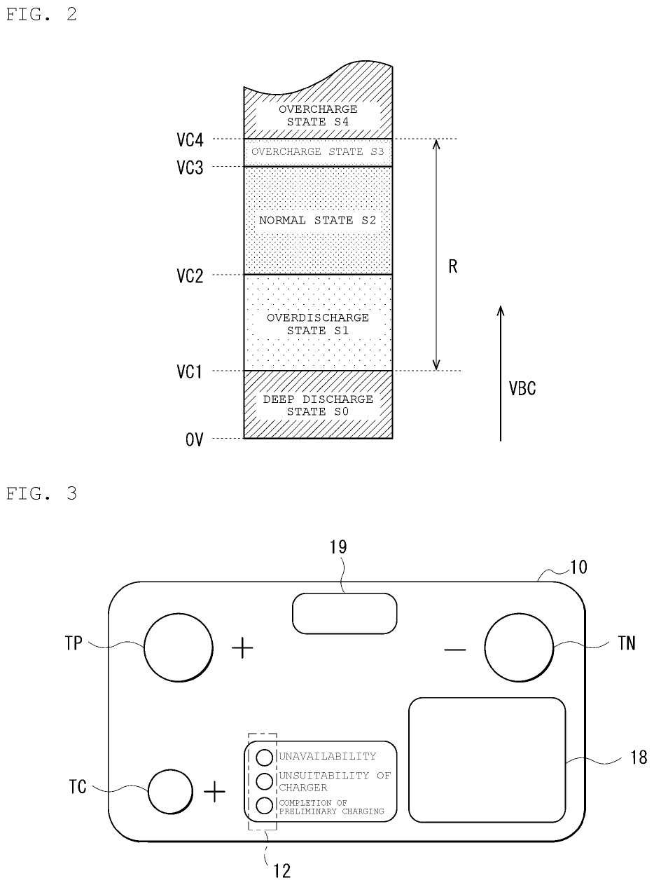

FIG. 2 illustrates an example of an operation state of the battery cell BC. In FIG. 2, the vertical axis represents a cell voltage VBC between a positive terminal and a negative terminal of the battery cell BC. In this example, the battery cell BC is an olivine type lithium iron phosphate ion secondary battery. The battery cell BC may have five cell states (deep discharge state S0, overdischarge state S1, normal state S2, overcharge state S3, and overcharge state S4).

The deep discharge state S0 is a cell state of the battery cell BC in a case where the cell voltage VBC is lower than a recharge prohibition voltage VC1. The recharge prohibition voltage VC1 is, for example, 1 V. The deep discharge state S0 indicates, for example, that a short circuit occurs inside the battery cell BC. Therefore, the battery cell BC in the deep discharge state S0 is out of order and cannot be used.

The overdischarge state S1 is a cell state of the battery cell BC in a case where the cell voltage VBC is equal to or more than the recharge prohibition voltage VC1 and lower than a discharge end voltage VC2. The discharge end voltage VC2 is, for example, 2.5 V. The battery cell BC should not be discharged in this overdischarge state S1 and needs to be charged with low charging current until the cell state becomes the normal state S2.

The normal state S2 is a cell state of the battery cell BC in a case where the cell voltage VBC is equal to or more than the discharge end voltage VC2 and lower than a charge end voltage VC3. The charge end voltage VC3 is, for example, 3.6 V. The battery cell BC can perform normal charging and discharging in this normal state S2.

The overcharge state S3 is a cell state of the battery cell BC in a case where the cell voltage VBC is equal to or more than the charge end voltage VC3 and lower than an overcharge protection voltage VC4. The overcharge protection voltage VC4 is, for example, 4 V. The battery cell BC should not be charged in this overcharge state S3 and needs to be discharged until the cell state becomes the normal state S2.

The overcharge state S4 is a cell state of the battery cell BC in a case where the cell voltage VBC is equal to or more than the overcharge protection voltage VC4. In this overcharge state S4, the battery cell BC is excessively charged, and a problem may occur. Therefore, the battery cell BC in the overcharge state S4 cannot be used.

The battery cell BC can be used in a voltage range (usable range R) where the cell voltage VBC is equal to or more than the recharge prohibition voltage VC1 and lower than the overcharge protection voltage VC4, and cannot be used at other voltages. In the battery pack 10, the cell voltage VBC of each of four of the battery cells BC1 to BC4 is monitored. The battery pack 10 can be used only in a case where all the cell voltages VBC of four of the battery cells BC1 to BC4 are within the usable range R.

The control circuit 12 (FIG. 1) is configured using, for example, a microcomputer, and is configured to monitor the cell voltage VBC of each of the battery cells BC1 to BC4. The control circuit 12 detects a voltage of a negative electrode of the battery cell BC1 as a voltage V0, detects a voltage of a positive electrode of the battery cell BC1 and a negative electrode of the battery cell BC2 as a voltage V1, detects a voltage of a positive electrode of the battery cell BC2 and a negative electrode of the battery cell BC3 as a voltage V2, detects a voltage of a positive electrode of the battery cell BC3 and a negative electrode of the battery cell BC4 as a voltage V3, and detects a voltage of a positive electrode of the battery cell BC4 as a voltage V4. The control circuit 12 monitors the cell voltage VBC of each of the battery cells BC1 to BC4 based on the voltages V0 to V4. Then, the control circuit 12 notifies the ECU 2 of a result of the monitoring via the connector 19. Specifically, for example, when the cell voltage VBC of any one of the battery cells BC1 to BC4 is lower than the discharge end voltage VC2, the control circuit 12 sets a discharge alert signal SAD to active voltage. For example, when the cell voltage VBC of any one of the battery cells BC1 to BC4 is equal to or more than the charge end voltage VC3, the control circuit 12 sets the charge alert signal SAC to active voltage. Further, the control circuit 12 can communicate with the ECU 2 using a communication signal COM.

The control circuit 12 includes power supply terminals TVCC and TGND and a terminal EXTCH. The power supply terminal TVCC is a terminal to which a power supply voltage VCC of the control circuit 12 is supplied. The power supply terminal TVCC is connected to cathodes of the diodes D1 and D3. The power supply terminal TGND is a terminal to which a ground voltage GND of the control circuit 12 is supplied. The power supply terminal TGND is connected to a negative electrode of the battery cell BC1 and the negative terminal TN of the battery pack 10. The terminal EXTCH is connected to the charging terminal TC of the battery pack 10 and anodes of the diodes D1 and D2. The control circuit 12 detects a voltage applied to the charging terminal TC in a preliminary charging mode to be described later. That is, in a case where a battery voltage of the battery pack 10 is low and the engine starter 4 cannot start the engine 5, the user connects a charger or an external battery to the charging terminal TC of the battery pack 10. In this case, the control circuit 12 operates in the preliminary charging mode, and detects whether the voltage applied to the charging terminal TC is a voltage within a predetermined voltage range.

Further, the control circuit 12 also has a function of controlling operation of the indicator 14 and the buzzer 15 based on the cell voltage VBC of each of the battery cells BC1 to BC4 and voltage applied to the charging terminal TC in the preliminary charging mode.

The control circuit 12 includes a memory 13. The memory 13 is, for example, a nonvolatile semiconductor memory, and stores a failure flag F and an error history. For example, in a case where the cell voltage VBC of any one of the battery cells BC1 to BC4 is lower than the recharge prohibition voltage VC1, the control circuit 12 sets the failure flag F and stores an error history indicating that there is the battery cell BC in the deep discharge state S0 in the memory 13. For example, in a case where the cell voltage VBC of any one of the battery cells BC1 to BC4 is equal to or more than the overcharge protection voltage VC4, the control circuit 12 sets the failure flag F and stores an error history indicating that there is the battery cell BC in the overcharge state S4 in the memory 13. Further, for example, in a case where variation in the cell voltage VBC of the battery cells BC1 to BC4 is a predetermined amount or more, the control circuit 12 sets the failure flag F and stores an error history indicating that the cell voltage VBC is unbalanced in the memory 13.

An anode of the diode D1 is connected to the charging terminal TC of the battery pack 10, an anode of the diode D2, and the terminal EXTCH of the control circuit 12, and a cathode is connected to a cathode of the diode D3 and the power supply terminal TVCC of the control circuit 12.

An anode of the diode D2 is connected to the charging terminal TC of the battery pack 10, the anode of the diode D1, and the terminal EXTCH of the control circuit 12, and a cathode is connected to the resistive element R1.

An anode of the diode D3 is connected to a positive electrode of the battery cell BC4, the resistive element R1, and the positive terminal TP of the battery pack 10, and a cathode is connected to the cathode of the diode D1 and the power supply terminal TVCC of the control circuit 12.

One end of the resistive element R1 is connected to the cathode of the diode D2, and the other end is connected to a positive electrode of the battery cell BC4, the anode of the diode D3, and the positive terminal TP of the battery pack 10.

The indicator 14 is configured to notify the user of a status of the battery pack 10 based on an instruction from the control circuit 12.

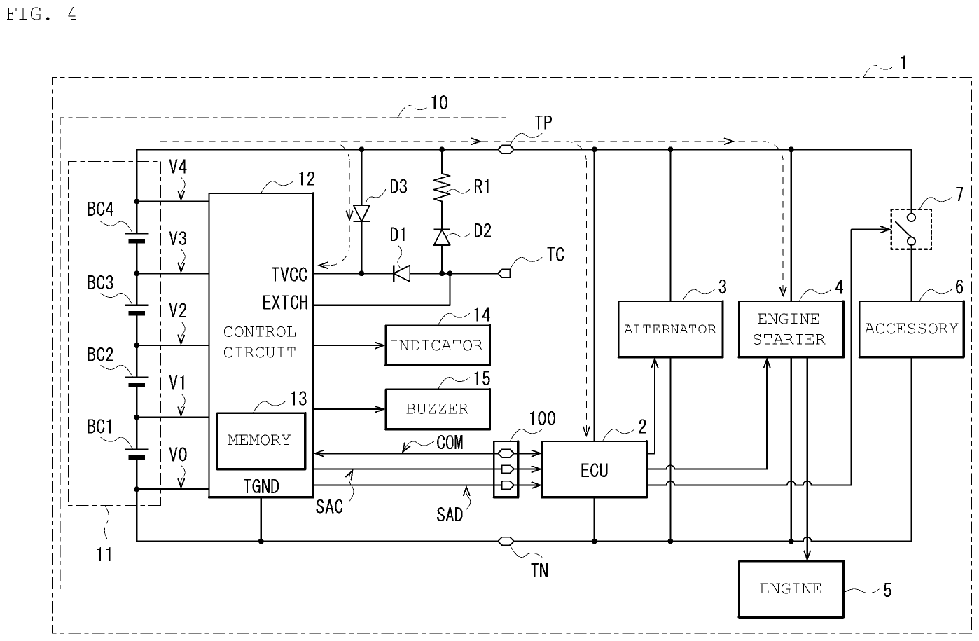

FIG. 3 represents an example of an appearance of the battery pack 10. On the front of the battery pack 10, the positive terminal TP, the negative terminal TN, the charging terminal TC, the connector 19, the indicator 14, and a label 18 are provided.

The indicator 14 has three light emitting diodes (LEDs) in this example. The three LEDs include an LED indicating unusability, an LED indicating unsuitability of a charger, and an LED indicating completion of preliminary charging.

The LED indicating unusability is configured to be turned on in a case where the battery pack 10 is unusable. Specifically, the LED indicating unusability is turned on in a case where the failure flag F stored in the memory 13 is set. The LED indicating unusability emits, for example, red light so as to call the user's attention.

The LED indicating unsuitability of a charger is configured to be turned on in a case where a charger connected to the charging terminal TC is not suitable in the preliminary charging mode. Specifically, the LED indicating unsuitability of a charger is turned on in a case where a voltage applied to the charging terminal TC is not a voltage within a predetermined voltage range. The LED indicating unsuitability of a charger emits, for example, red light so as to call the user's attention.

The LED indicating completion of preliminary charging is configured to be turned on in a case where preliminary charging is completed in the preliminary charging mode. Specifically, in a case where the cell voltage VBC of any one of the battery cells BC1 to BC4 is lower than the discharge end voltage VC2, the LED indicating completion of preliminary charging is turned on in a case where the cell voltage VBC of all of the battery cells BC1 to BC4 becomes equal to or more than the discharge end voltage VC2 as preliminary charging is performed. The LED indicating completion of preliminary charging is configured to emit, for example, blue light so as to prompt the user to proceed to a next step.

The label 18 is printed with a user's operation procedure when preliminary charging is performed for the battery pack 10. By checking the label 18, the user can grasp an operation procedure when performing preliminary charging.

The buzzer 15 (FIG. 1) is configured to notify the user of a status of the battery pack 10 by operating based on an instruction from the control circuit 12.

The ECU 2 is configured to control operation of the vehicle 1. In this example, the ECU 2 controls operation of the alternator 3, the engine starter 4 and the switch 7. The ECU 2 operates on the basis of power supplied from the battery pack 10 or power generated by the alternator 3. Further, the ECU 2 also has a function of performing charge and discharge control on the battery pack 10 based on a signal supplied from the battery pack 10 via the connector 19.

The alternator 3 is configured to generate power by using a driving force of the engine 5 as a power source. Then, the alternator 3 supplies the generated power to the battery pack 10, the ECU 2, and the accessory 6.

The engine starter 4 is configured to start the engine 5 based on power supplied from the battery pack 10. The engine starter 4 operates based on an instruction from the ECU 2.

The engine 5 is a power source that generates a driving force, which is mechanical energy, by burning fuel such as gasoline, for example. The vehicle 1 travels based on a driving force generated by the engine 5. The engine 5 is started by the engine starter 4.

The accessory 6 is electric equipment such as a dashboard camera or an audio device. The accessory 6 operates based on power supplied from the battery pack 10 or power generated by the alternator 3.

The switch 7 is provided in a power supply path to the accessory 6, and is configured to supply power to the accessory 6 or stop power supply to the accessory 6 based on an instruction from the ECU 2.

Here, the secondary battery 11 corresponds to a specific example of a “secondary battery” in the present disclosure. The battery cell BC corresponds to a specific example of a “battery cell” in the present disclosure. The positive terminal TP corresponds to a specific example of a “positive terminal” in the present disclosure. The negative terminal TN corresponds to a specific example of a “negative terminal” in the present disclosure. The charging terminal TC corresponds to a specific example of a “charging terminal” in the present disclosure. The control circuit 12 corresponds to a specific example of a “control circuit” in the present disclosure. The power supply terminal TVCC corresponds to a specific example of a “power supply terminal” in the present disclosure. The resistive element R1 corresponds to a specific example of a “current limiting element” in the present disclosure. The indicator 14 and the buzzer 15 correspond to a specific example of a “notification unit” in the present disclosure. The diode D1 corresponds to a specific example of a “first diode” in the present disclosure. The diode D2 corresponds to a specific example of a “second diode” in the present disclosure. The diode D3 corresponds to a specific example of a “third diode” in the present disclosure. The engine 5 corresponds to a specific example of a “driving force generation unit” in the present disclosure. The ECU 2 corresponds to a specific example of a “drive control unit” in the present disclosure.

Next, operation and a function of the vehicle 1 of the present embodiment will be described.

First, the summary of entire operation of the vehicle 1 will be described with reference to FIG. 1. The battery pack 10 stores power. The ECU 2 controls operation of the vehicle 1, and performs charge and discharge control on the battery pack 10 based on a signal supplied from the battery pack 10 via the connector 19. The alternator 3 uses a driving force of the engine 5 as a power source to generate power. The engine starter 4 starts the engine 5 based on power supplied from the battery pack 10. The engine 5 generates a driving force which is mechanical energy by burning fuel such as gasoline, for example.

In the battery pack 10, the control circuit 12 monitors the cell voltage VBC of each of the battery cells BC1 to BC4, and notifies the ECU 2 of a result of the monitoring via the connector 19. Further, in the preliminary charging mode, the control circuit 12 controls operation of the indicator 14 and the buzzer 15 based on the cell voltage VBC of each of the battery cells BC1 to BC4 and voltage applied to the charging terminal TC. The indicator 14 and the buzzer 15 notify the user of a status of the battery pack 10 based on an instruction from the control circuit 12.

Hereinafter, operation of the vehicle 1 in a case where a cell state of four of the battery cells BC in the battery pack 10 is the normal state S2 will be described with some examples.

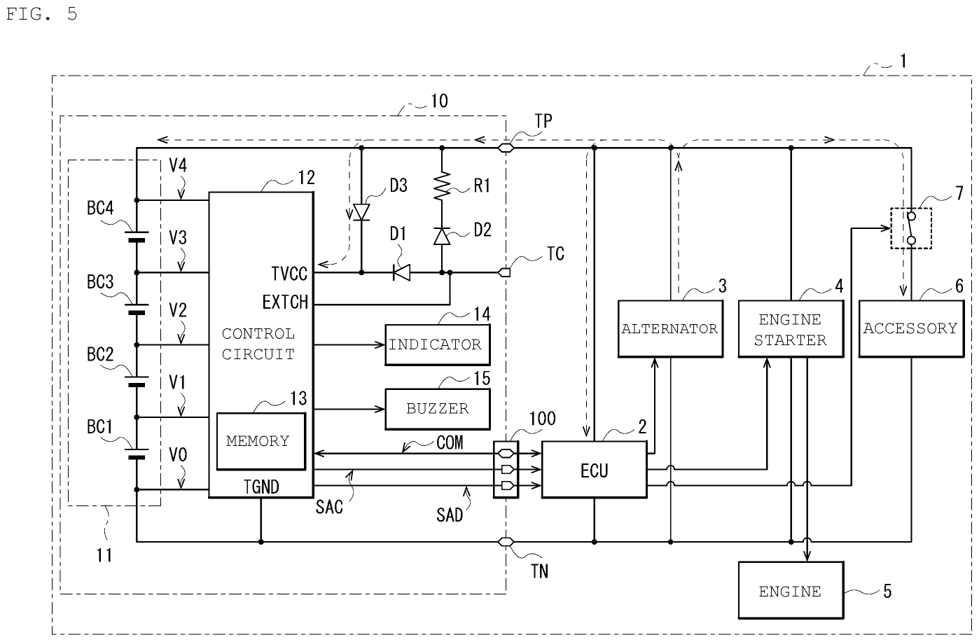

FIG. 4 illustrates an example of operation of the vehicle 1 in a case where the engine 5 is started. In FIG. 4, a broken line arrow indicates flow of current. In the battery pack 10, the secondary battery 11 supplies power to the control circuit 12 via the diode D3. The control circuit 12 operates on the basis of power supplied from the secondary battery 11. The battery pack 10 supplies power to the ECU 2 and the engine starter 4. For example, when the user presses an engine start switch (not illustrated), the ECU 2 instructs the engine starter 4 to start the engine 5. Then, the engine starter 4 starts the engine 5 based on power supplied from the battery pack 10. In this manner, discharging current from the battery pack 10 flows to the ECU 2 and the engine starter 4.

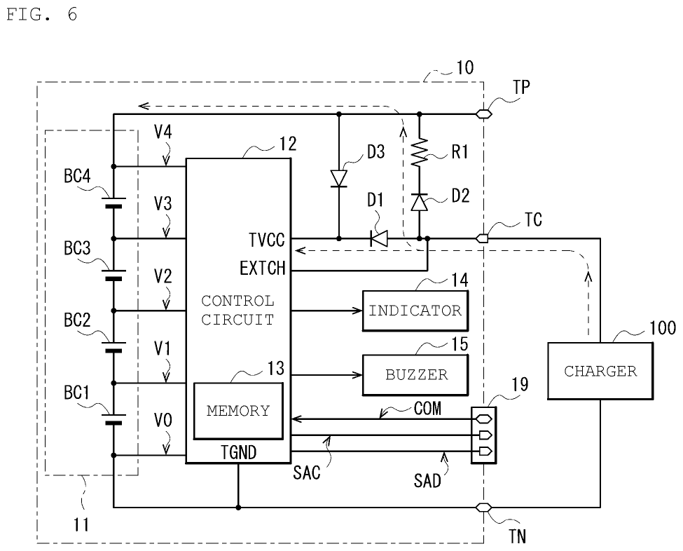

FIG. 5 illustrates an example of operation of the vehicle 1 in a case where the vehicle 1 is traveling. The engine 5 generates a driving force, and the vehicle 1 travels based on the driving force. The alternator 3 uses a driving force of the engine 5 as a power source to generate power. The alternator 3 supplies power to the ECU 2, the accessory 6, and the battery pack 10. The ECU 2 controls operation of the alternator 3 and turns on the switch 7. By the above, charging current flows through the secondary battery 11 of the battery pack 10. In the battery pack 10, power is supplied to the control circuit 12 via the diode D3.

This operation is the same as that of a vehicle including a general auxiliary battery configured using a lead battery. Therefore, the battery pack 10 can be used instead of such a lead battery.

In the vehicle 1, in a case where battery voltage of the battery pack 10 is low and the engine starter 4 cannot start the engine 5, the user connects a charger or an external battery to the charging terminal TC. By the above, the battery pack 10 is charged. Hereinafter, operation of the preliminary charging will be described.

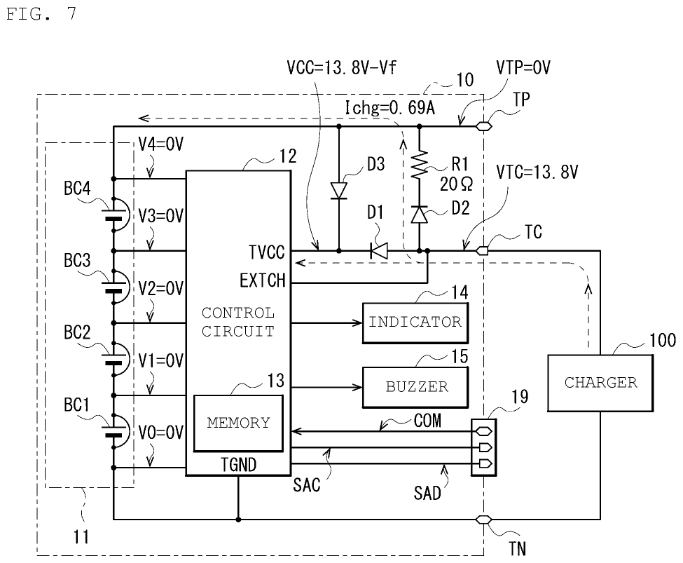

FIG. 6 illustrates operation of preliminary charging for the battery pack 10. In FIG. 6, the vehicle 1 is not illustrated. This preliminary charging is performed, for example, in a state where the battery pack 10 is mounted on the vehicle 1. In this example, a cell state of the battery cells BC1 to BC4 is the overdischarge state S1, battery voltage of the battery pack 10 is low, and the engine starter 4 cannot start the engine 5. In this case, the user inserts and connects a charger 100 between the charging terminal TC and the negative terminal TN of the battery pack 10. Note that, in this example, the charger 100 is connected, but the present technology is not limited to this, and an external battery may be connected. Power supplied from the charger 100 is supplied to the power supply terminal TVCC of the control circuit 12 via the charging terminal TC and the diode D1. By the above, the control circuit 12 operates. Further, power supplied from the charger 100 is supplied to the secondary battery 11 via the charging terminal TC, the diode D2, and the resistive element R1. That is, charging current flows from the charger 100 to the secondary battery 11 via the charging terminal TC, the diode D2, and the resistive element R1. In this manner, the secondary battery 11 is charged, and a cell state of the battery cells BC1 to BC4 changes from the overdischarge state S1 to the normal state S2. In this way, preliminary charging is completed.

As described above, in a case where preliminary charging is performed on the battery pack 10 and there is a problem in the secondary battery 11, it is desirable that the control circuit 12 can detect the problem in the secondary battery 11. Hereinafter, operation during preliminary charging will be described with reference to two cases C1 and C2.

The case C1 illustrates a case where all of four of the battery cells BC1 to BC4 are short-circuited inside or outside the battery cell BC.

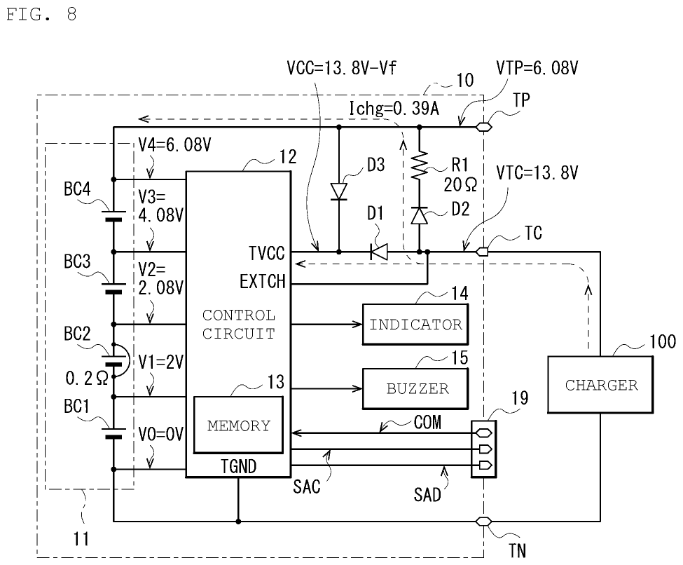

FIG. 7 illustrates operation of preliminary charging in the case C1. In FIG. 7, a line connecting a positive electrode and a negative electrode of the battery cell BC is drawn to indicate that the battery cell BC is short-circuited. In this example, output voltage of the charger 100 is 13.8 V, and current supply capability is 5 A. Further, a resistance value of the resistive element R1 is 20Ω. Voltage between both ends of the resistive element R1 is represented by “13.8 V-Vf2”. Here, a voltage Vf2 is a forward voltage of the diode D2. When the voltage Vf2 is ignored, a charging current Ichg is 0.69 A (=13.8 V/20Ω) and equal to or less than 5 A, so the charger 100 can provide this current. In this case, a voltage VTC at the charging terminal TC is 13.8 V, and a voltage VTP at the positive terminal TP is 0 V.

The power supply voltage VCC supplied to the power supply terminal TVCC of the control circuit 12 is “13.8 V-Vf1”. Here, a voltage Vf1 is a forward voltage of the diode D1. As described above, since the sufficiently high power supply voltage VCC exceeding a starting voltage of the control circuit 12 is supplied to the control circuit 12, the control circuit 12 can operate. In this example, since all of four of the battery cells BC1 to BC4 are short-circuited, the control circuit 12 can detect that all of the cell voltages VBC of four of the battery cells BC1 to BC4 are lower than the recharge prohibition voltage VC1.

The case C2 illustrates a case where one of four of the battery cells BC1 to BC4 is short-circuited.

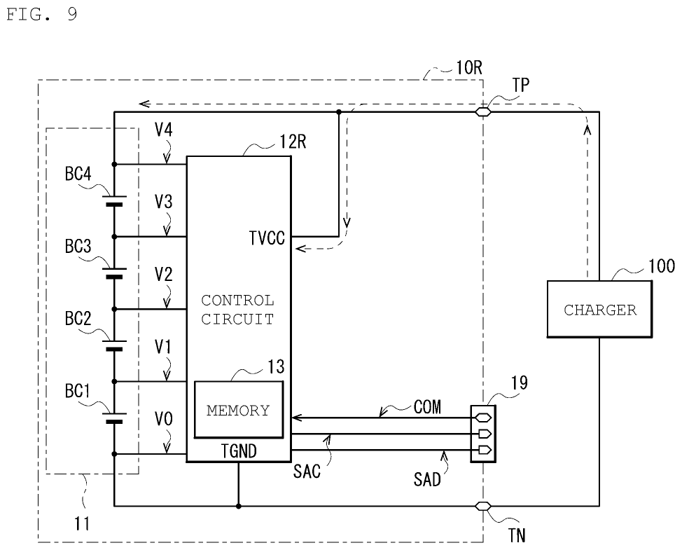

FIG. 8 illustrates operation of preliminary charging in the case C2. In this example, among four of the battery cells BC1 to BC4, the battery cell BC2 is short-circuited. A resistance value between both poles of the battery cell BC2 is 0.2Ω. The cell voltage VBC of each of the battery cells BC1, BC3, and BC4 is 2 V. A voltage between both ends of the resistive element R1 is represented by “13.8 V-6 V-Vf2-VBC2”. A voltage VBC2 is equivalent to a voltage drop in the battery cell BC2. When the voltages VBC2 and Vf2 are ignored, the charging current Ichg is 0.39 A (=(13.8 V-6 V)/20Ω) and is 5 A or less, so the charger 100 can supply this current. A voltage between both poles of the battery cell BC2 is about 0.08 V (=0.2Ω(2×0.39 A). In this case, the voltage VTC at the charging terminal TC is 13.8 V, and the voltage VTP at the positive terminal TP is 6.08 V.

The power supply voltage VCC supplied to the power supply terminal TVCC of the control circuit 12 is “13.8 V-Vf1”. As described above, since the sufficiently high power supply voltage VCC exceeding a starting voltage of the control circuit 12 is supplied to the control circuit 12, the control circuit 12 can operate. In this example, since the battery cell BC2 is short-circuited, the control circuit 12 can detect that the cell voltage VBC of the battery cell BC2 is lower than the recharge prohibition voltage VC1.

Next, a function of the present embodiment will be described with some comparative examples.

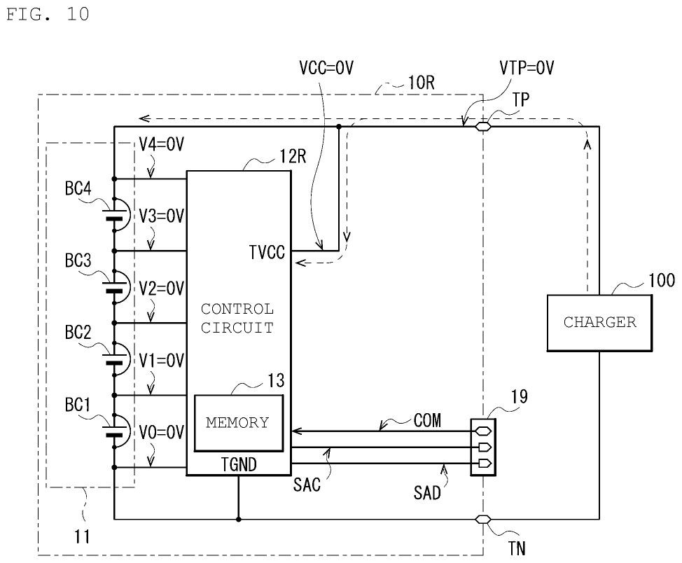

FIG. 9 illustrates a configuration example of a battery pack 10R according to a comparative example. The battery pack 10R includes the secondary battery 11, a control circuit 12R, and the connector 19. In the battery pack 10R, the diodes D1 to D3, the resistive element R1, the indicator 14, and the buzzer 15 are omitted, and the control circuit 12 is replaced with the control circuit 12R in the battery pack 10 (FIG. 1) according to the present embodiment. Similarly to the control circuit 12 according to the present embodiment, the control circuit 12R is configured to monitor the cell voltage VBC of each of the battery cells BC1 to BC4 and notify the ECU 2 of a result of the monitoring via the connector 19. The control circuit 12R has the power supply terminals TVCC and TGND.

In a case of performing preliminary charging on the battery pack 10R, the user inserts and connects the charger 100 between the positive terminal TP and the negative terminal TN of the battery pack 10R. Power supplied from the charger 100 is supplied to the power supply terminal TVCC of the control circuit 12 and to the secondary battery 11 via the positive terminal TP. That is, charging current directly flows from the charger 100 to the secondary battery 11. In this manner, the secondary battery 11 is charged, and a cell state of the battery cells BC1 to BC4 changes from the overdischarge state S1 to the normal state S2.

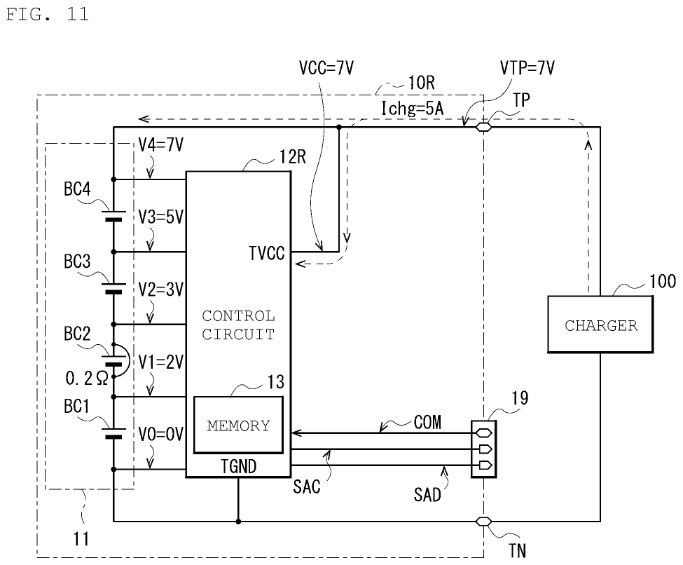

FIG. 10 illustrates operation of preliminary charging in the case C1 of the battery pack 10R according to the comparative example. In the case C1, all of four of the battery cells BC1 to BC4 are short-circuited. In this example, output voltage of the charger 100 is 13.8 V, and current supply capability is 5 A. Therefore, since current to flow into the battery pack 10R exceeds current supply capability of the charger 100, the charger 100 cannot supply a voltage of 13.8 V to the battery pack 10R. As a result, the voltage VTP at the positive terminal TP is 0 V, and the power supply voltage VCC supplied to the power supply terminal TVCC of the control circuit 12R is also 0 V. As described above, since the power supply voltage VCC is lower than a starting voltage of the control circuit 12R, the control circuit 12R is not started. As a result, the control circuit 12R cannot monitor the cell voltage VBC of each of the battery cells BC1 to BC4. In this example, all of four of the battery cells BC1 to BC4 are short-circuited, but the control circuit 12R cannot detect that all of the cell voltages VBC of these four of the battery cells BC1 to BC4 are lower than the recharge prohibition voltage VC1.

On the other hand, in the battery pack 10 (FIG. 7) according to the present embodiment, since the resistive element R1 is provided, charging current can be limited in a case where all of four of the battery cells BC1 to BC4 are short-circuited. In this example, since charging current can be limited to current within a range of current supply capability of the charger 100, output voltage of the charger 100 can be prevented from being lowered. Then, in the battery pack 10, voltage supplied from the charger 100 can be supplied to the power supply terminal TVCC of the control circuit 12 via the diode D1, so that the control circuit 12 can be operated more reliably.

As described above, in the battery pack 10 according to the present embodiment, in a case where all of four of the battery cells BC1 to BC4 are short-circuited inside or outside the battery cells BC and battery voltage of the secondary battery 11 is lower than a starting voltage of the control circuit 12, the control circuit 12 can be started by connecting the charger 100 to the charging terminal TC.

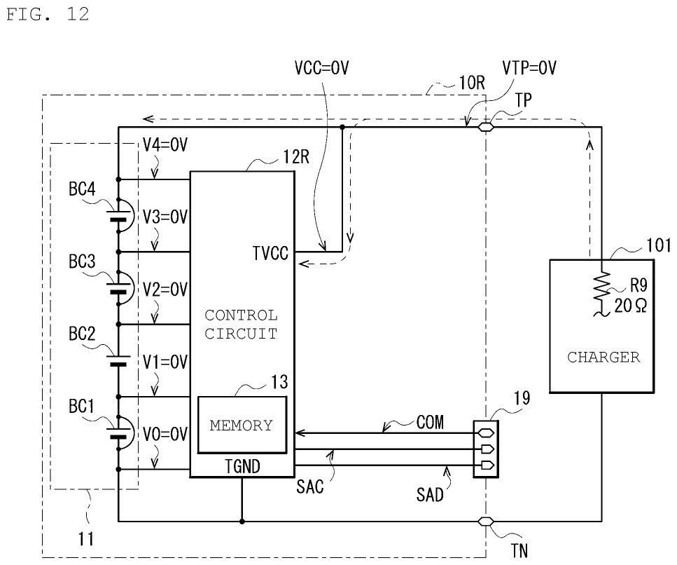

FIG. 11 illustrates operation of preliminary charging in the case C2 of the battery pack 10R according to the comparative example. In the case C2, one of four of the battery cells BC1 to BC4 (battery cell BC2 in this example) is short-circuited, and a resistance value between both poles of battery cell BC2 is 0.2Ω. In this example, output voltage of the charger 100 is 13.8 V, and current supply capability is 5 A. Therefore, since current to flow into the battery pack 10R exceeds current supply capability of the charger 100, the charger 100 cannot supply a voltage of 13.8 V to the battery pack 10R. As a result, the charging current Ichg is 5 A, the voltage VTP at the positive terminal TP is 7 V, and the power supply voltage VCC supplied to the power supply terminal TVCC of the control circuit 12R is also 7 V. In this case, the power supply voltage VCC may exceed a starting voltage of the control circuit 12R. In a case where the power supply voltage VCC exceeds a starting voltage of the control circuit 12R, the control circuit 12R can be started and monitor the cell voltage VBC of each of the battery cells BC1 to BC4. However, in this example, since the cell voltage VBC of the battery cell BC2 is 1 V (=0.2 Ω×5 A), the control circuit 12R determines that the cell voltage VBC of the battery cell BC2 is equal to or more than the recharge prohibition voltage VC1. That is, in this example, although the battery cell BC2 is short-circuited, the control circuit 12R determines that the cell voltage VBC of the battery cell BC2 is equal to or more than the recharge prohibition voltage VC1.

On the other hand, in the battery pack 10 (FIG. 8) according to an embodiment, since the resistive element R1 is provided, for example, in a case where one of four of the battery cells BC1 to BC4 is short-circuited, charging current can be limited. As a result, since an amount of a voltage drop in the short-circuited battery cell BC can be reduced, a problem of the battery cell BC can be more reliably detected.

As described above, in the battery pack 10 according to the present embodiment, since charging current is limited by the resistive element R1, the short-circuited battery cell BC and the battery cell BC in the deep discharge state S0 can be more reliably detected.

As described above, in the battery pack 10, charging current is limited by insertion of the resistive element R1 into a path through which the charging current flows. Next, an example in which a resistive element for limiting charging current is provided in a charger will be described as a comparative example E2.

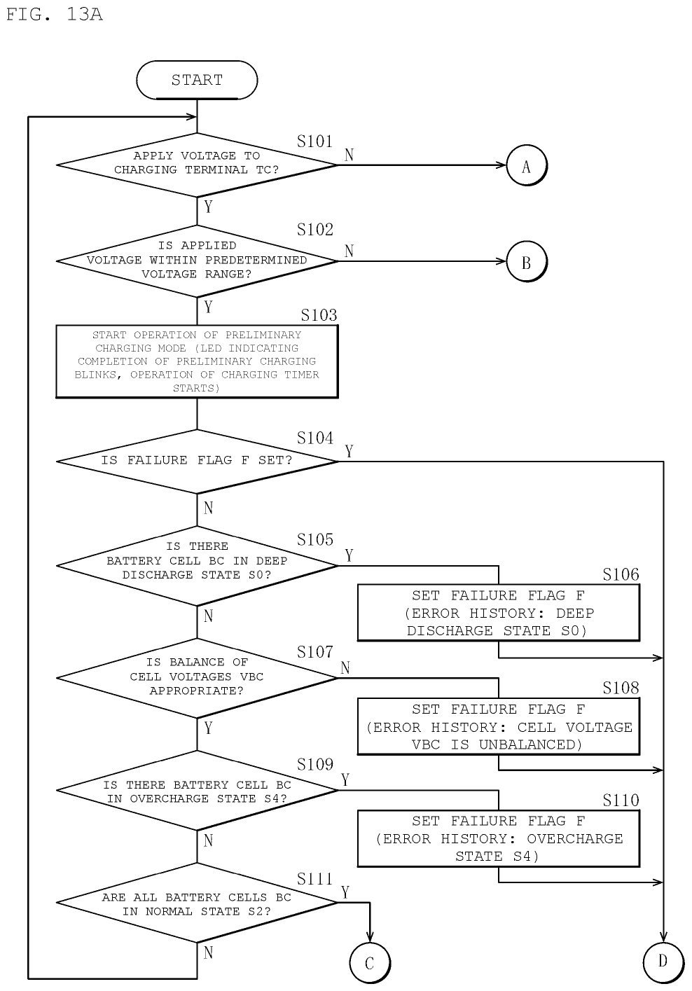

FIG. 12 illustrates operation of preliminary charging in the case C1 of the battery pack 10R according to the comparative example. In a case of performing preliminary charging on the battery pack 10R, the user inserts and connects a charger 101 between the positive terminal TP and the negative terminal TN of the battery pack 10R. The charger 101 includes a resistive element R9 provided in a current supply path. In this example, output voltage of the charger 101 is 13.8 V, and current supply capability is 5 A. Further, a resistance value of the resistive element R9 is 20Ω. By the above, charging current is limited similarly to the case of the present embodiment. However, in this example, the voltage VTP at the positive terminal TP is 0 V, and the power supply voltage VCC supplied to the power supply terminal TVCC of the control circuit 12R is also 0 V. As described above, since the power supply voltage VCC is lower than a starting voltage of the control circuit 12R, the control circuit 12R is not started. As a result, the control circuit 12R cannot monitor the cell voltage VBC of each of the battery cells BC1 to BC4.

On the other hand, in the battery pack 10 (FIG. 7) according to the present embodiment, the resistive element R1 is provided on a path connecting the charging terminal TC and the positive terminal TP. Then, the charging terminal TC is connected to the power supply terminal TVCC of the control circuit 12 via the diode D1. By the above, not a voltage dropped by the resistive element R1 but a voltage corresponding to the voltage VTC at a charging terminal VC is supplied to the control circuit 12 as the power supply voltage VCC. Therefore, since the control circuit 12 is supplied with the sufficiently high power supply voltage VCC exceeding a starting voltage of the control circuit 12, the control circuit 12 operates and can monitor the cell voltage VBC of each of the battery cells BC1 to BC4.

For example, in order to rescue a vehicle in which an auxiliary battery runs out and an engine cannot be started, a road service provider rushes to a location of the vehicle by bringing a charger, an external battery, a tester for measuring a battery voltage, an electrolyte hydrometer, and the like. Then, the provider starts an engine of the vehicle. Hereinafter, an operation procedure of a provider (hereinafter, also referred to as the user) in a case of rescuing the vehicle 1 including the battery pack 10 illustrated in FIG. 1 will be described.

First, the user connects one end of a red booster cable to the charging terminal TC of the battery pack 10 mounted on the vehicle 1 (first operation).

Next, the user connects the other end of the red booster cable to a positive electrode of the charger 100 (second operation).

Next, the user connects one end of a black booster cable to a negative electrode of the charger 100 (third operation).

Next, the user connects the other end of the black booster cable to the engine 5 of the vehicle 1 (fourth operation). Note that the engine 5 is electrically connected to the negative terminal TN of the battery pack 10. By the above, in the battery pack 10, preliminary charging is started. In the battery pack 10, charging current flows to the secondary battery 11 via the charging terminal TC, the diode D2, and the resistive element R1 as illustrated in FIG. 6.

Next, the user waits until the LED indicating completion of preliminary charging is turned on (fifth operation). In a case where the LED indicating unusability or the LED indicating unsuitability of a charger is turned on, the user immediately disconnects a booster cable or operates the charger 100, for example, to stop charging (sixth operation).

In a case where the LED indicating completion of preliminary charging is turned on, one end of the red booster cable is reconnected from the charging terminal TC of the battery pack 10 to the positive terminal TP (seventh operation). By the above, power is supplied from the charger 100 to the ECU 2 and the engine starter 4 of the vehicle 1.

Next, the user operates the vehicle 1 to start the engine 5 of the vehicle 1 (eighth operation). Specifically, for example, when the user presses an engine start switch (not illustrated), the ECU 2 instructs the engine starter 4 to start the engine 5. Then, the engine starter 4 starts the engine 5 based on power supplied from the battery pack 10.

Then, the user disconnects the booster cable (ninth operation).

The user can rescue the vehicle 1 including the battery pack 10 by performing such work. The first operation, the fifth operation, the sixth operation, and the seventh operation are operations different from operation for a vehicle including a general auxiliary battery configured using a lead battery. This operation procedure is printed on the label 18 (FIG. 3), and the user can perform work by looking at description on the label 18. Therefore, for example, a worker who has only experience of rescuing a vehicle including a general auxiliary battery can perform the work, so that the convenience of the user can be enhanced.

As described above, in the battery pack 10 according to the present embodiment, the control circuit 12 monitors the cell voltages VBC of four of the battery cells BC1 to BC4, and an LED of the indicator 14 notifies the user of a status of the battery pack 10. Therefore, for example, the user can perform the work efficiently. Further, for example, in a case where there is a problem with the battery pack 10, the user can know a state of the battery pack 10, and make a determination to stop the work. As a result, the convenience of the user can be enhanced.

A road service provider may rescue various vehicles. An auxiliary battery of a vehicle may be of various types, for example an auxiliary battery configured using a lead battery. In order to be able to cope with such various types of auxiliary batteries, a provider may prepare a dedicated charger, a dedicated battery, a dedicated measuring instrument, a dedicated cable, and the like. However, in this case, the provider needs to have knowledge about handling of these devices and cables. Therefore, the provider preparing various types of devices and cables depending on a type of an auxiliary battery causes heavy burden on the provider, and it is inefficient.

In the battery pack 10 according to the present embodiment, a charger, a measuring instrument, and the like used for a general auxiliary battery configured using a lead battery can be used. Then, the provider can perform operation by looking at description on the label 18. As a result, burden on the provider can be reduced.

Next, operation of the battery pack 10 in preliminary charging will be described. When a cell state of at least one of four of the battery cells BC1 to BC4 changes from the normal state S2 to the overdischarge state S1, the control circuit 12 becomes in a power-down state. Then, in a case where the control circuit 12 is in such a power-down state, for example, when the user connects the charger 100 to the battery pack 10, the control circuit 12 starts operation by performing a power-on reset operation. Hereinafter, operation of the control circuit 12 after the power-on reset operation will be described.

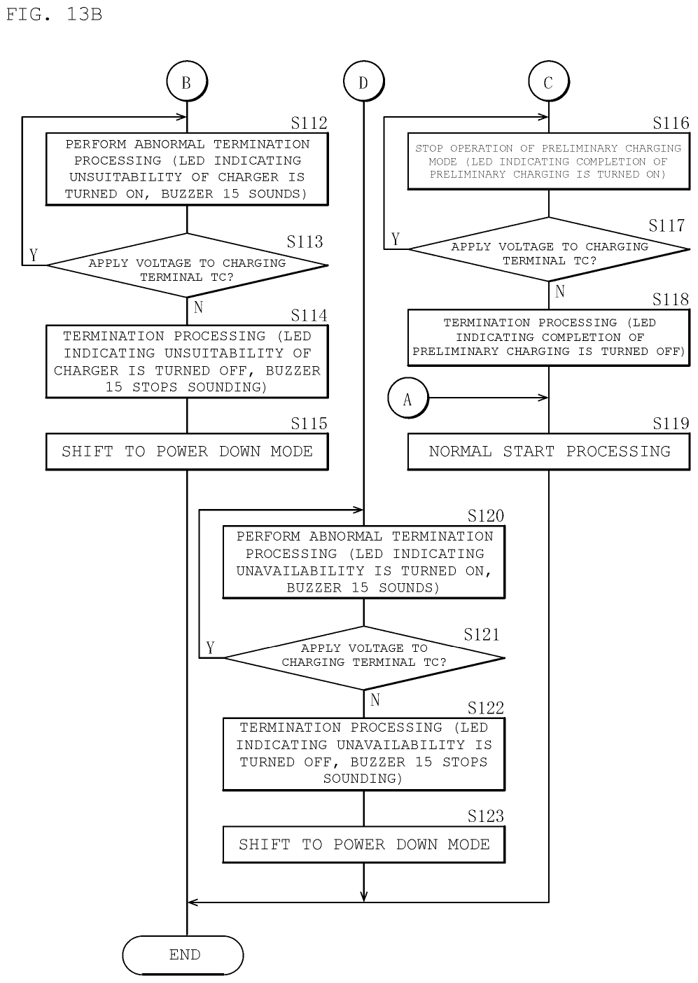

FIGS. 13A and 13B illustrate operation of the control circuit 12 after the power-on reset operation.

First, the control circuit 12 detects a voltage at the terminal EXTCH to check whether or not voltage is applied to the charging terminal TC (Step S101). In a case where no voltage is applied to the charging terminal TC (“N” in Step S101), the control circuit 12 performs normal start processing (Step S119).

In Step S101, in a case where voltage is applied to the charging terminal TC (“Y” in Step S101), the control circuit 12 checks whether or not the voltage applied to the charging terminal TC is a voltage within a predetermined voltage range (Step S102). This predetermined voltage range can be, for example, a range of 12 V or more and 15 V or less.

In Step S102, in a case where the applied voltage is not a voltage within the predetermined voltage range (“N” in Step S102), the control circuit 12 performs abnormal termination processing (Step S112). That is, for example, in a case where the applied voltage is higher than the predetermined voltage range, there is a possibility that a cell state of the battery cell BC of the battery pack 10 becomes the overcharge states S3 and S4 as the charging is continued without being stopped. Therefore, the control circuit 12 performs the abnormal termination processing and operates to stop charging. In the abnormal termination processing, the control circuit 12 controls operation of the indicator 14 so that the LED indicating unsuitability of a charger is turned on, and controls operation of the buzzer 15 so that the buzzer 15 sounds.

Then, the control circuit 12 detects a voltage at the terminal EXTCH to check whether or not voltage is applied to the charging terminal TC (Step S113). Further, in a case where voltage is still applied (“Y” in Step S113), the processing returns to Step S112. In this manner, the control circuit 12 repeats the processing of Steps S112 and S113 until the user disconnects the charger 100 and the battery pack 10 and no voltage is applied to the charging terminal TC.

In Step S113, in a case where no voltage is applied to the charging terminal TC (“N” in Step S113), the control circuit 12 performs termination processing (Step S114). In this termination processing, the control circuit 12 controls operation of the indicator 14 so that the LED indicating unsuitability of a charger is turned off, and controls operation of the buzzer 15 so that the buzzer 15 stops sounding.

Then, the control circuit 12 shifts the operation mode to a power down mode (Step S115).

In Step S102, in a case where the applied voltage is a voltage within the predetermined voltage range (“Y” in Step S102), the control circuit 12 starts operation in the preliminary charging mode (Step S103). In this example, the control circuit 12 controls operation of the indicator 14 such that the LED indicating completion of preliminary charging blinks. Further, the control circuit 12 starts operation of a charging timer.

Next, the control circuit 12 checks whether or not the failure flag F is set (Step S104). In a case where the failure flag F is set (“Y” in Step S104), the processing proceeds to Step S120 (described later).

In Step S104, in a case where the failure flag F is not set (“N” in Step S104), the control circuit 12 checks whether or not there is the battery cell BC whose cell state is the deep discharge state S0 (Step S105). Specifically, the control circuit 12 compares the cell voltage VBC of each of four of the battery cells BC1 to BC4 with the recharge prohibition voltage VC1 to check whether or not there is the battery cell BC whose cell state is the deep discharge state S0. In a case where there is the battery cell BC whose cell state is the deep discharge state S0 (“Y” in Step S105), the control circuit 12 sets the failure flag F (Step S106). Further, the control circuit 12 stores an error history indicating that there is the battery cell BC in the deep discharge state S0 in the memory 13. Then, the processing proceeds to Step S120 (described later).

In Step S105, in a case where there is none of the battery cell BC whose cell state is the deep discharge state S0 (“N” in Step S105), the control circuit 12 checks whether or not the balance of the cell voltages VBC of four of the battery cells BC1 to BC4 is appropriate (Step S107).

For example, in a case where variation in the cell voltage VBC of the battery cells BC1 to BC4 is equal to or more than a predetermined amount, the control circuit 12 determines that the cell voltage VBC is unbalanced and not appropriate. In a case where the balance of the cell voltage VBC is not appropriate (“N” in Step S107), the control circuit 12 sets the failure flag F (Step S108). Further, the control circuit 12 stores an error history indicating that the cell voltage VBC is unbalanced in the memory 13. Then, the processing proceeds to Step S120 (described later).

In Step S107, in a case where the balance of the cell voltages VBC is appropriate (“Y” in Step S107), the control circuit 12 checks whether or not there is the battery cell BC whose cell state is the overcharge state S4 (Step S109). Specifically, the control circuit 12 compares the cell voltage VBC of each of four of the battery cells BC1 to BC4 with the overcharge protection voltage VC4 to check whether or not there is the battery cell BC whose cell state is the overcharge state S4. In a case where there is the battery cell BC whose cell state is the overcharge state S4 (“Y” in Step S109), the control circuit 12 sets the failure flag F (Step S110). Further, the control circuit 12 stores an error history indicating that there is the battery cell BC in the overcharge state S4 in the memory 13. Then, the processing proceeds to Step S120 (described later).

In Step S109, in a case where there is none of the battery cell BC whose cell state is the overcharge state S4 (“N” in Step S109), the control circuit 12 checks whether or not a cell state of all the battery cells BC is the normal state S2 (Step S111). In a case of “N” in the processing of Steps S105 and S109, a cell state of the battery cell BC is one of the overdischarge state S1, the normal state S2, and the overcharge state S3. In a case where a cell state of all the battery cells BC is not the normal state S2 (“N” in Step S111), the control circuit 12 returns to the processing of Step S101. The battery pack 10 repeats operation of Steps S101 to S110 and continues the operation in the preliminary charging mode until the cell state of all the battery cells BC becomes the normal state S2.

In Step S111, in a case where the cell state of all the battery cells BC is the normal state S2 (“Y” in Step S111), the control circuit 12 stops the operation in the preliminary charging mode (Step S116). Specifically, the control circuit 12 controls operation of the indicator 14 so that the LED indicating completion of preliminary charging is turned on.

Then, the control circuit 12 checks whether or not voltage is applied to the charging terminal TC by detecting voltage of the terminal EXTCH (Step S117). In a case where the voltage is still applied (“Y” in Step S117), the processing returns to Step S116. In this manner, the control circuit 12 repeats the processing of Steps S116 and S117 until the user disconnects the charger 100 and the battery pack 10 and no voltage is applied to the charging terminal TC.

In Step S117, in a case where no voltage is applied to the charging terminal TC (“N” in Step S117), the control circuit 12 performs termination processing (Step S118). In this termination processing, the control circuit 12 controls operation of the indicator 14 so that the LED indicating completion of preliminary charging is turned off.

Then, the control circuit 12 performs normal start processing (Step S119).

In Steps S104, S106, S108, and S110, in a case where the failure flag F is set, the control circuit 12 performs abnormal termination processing (Step S120). That is, for example, in a case where the failure flag F is set, in the battery pack 10, for example, there is the battery cell BC whose cell state is the deep discharge state S0, or there is the battery cell BC whose cell voltage VBC is unbalanced, or whose cell state is the overcharge state S4. In such a case, the battery pack 10 cannot be used. Therefore, in this case, the control circuit 12 performs the abnormal termination processing and operates to stop charging. In this abnormal termination processing, the control circuit 12 controls operation of the indicator 14 so that the LED indicating unusability is turned on, and controls operation of the buzzer 15 so that the buzzer 15 sounds.

Then, the control circuit 12 checks whether or not voltage is applied to the charging terminal TC by detecting voltage of the terminal EXTCH (Step S121). In a case where the voltage is still applied (“Y” in Step S121), the processing returns to Step S120. In this manner, the control circuit 12 repeats the processing of Steps S120 and S121 until the user disconnects the charger 100 and the battery pack 10 and no voltage is applied to the charging terminal TC.

In Step S121, in a case where no voltage is applied to the charging terminal TC (“N” in Step S121), the control circuit 12 performs termination processing (Step S122). In this termination processing, the control circuit 12 controls operation of the indicator 14 so that the LED indicating unusability is turned off, and controls operation of the buzzer 15 so that the buzzer 15 stops sounding.

Then, the control circuit 12 shifts the operation mode to a power down mode (Step S123).

By the above, this process ends.

As described above, in the battery pack 10, the secondary battery 11, the positive terminal TP and the negative terminal TN connected to the secondary battery 11, the control circuit 12 having the power supply terminal TVCC and capable of monitoring the secondary battery 11, the charging terminal TC guided to the power supply terminal TVCC of the control circuit 12, and the resistive element R1 provided in a current path connecting the positive terminal TP and the charging terminal TC are provided. By the above, in preliminary charging, charging current is limited by the resistive element R1. Therefore, for example, in a case where battery voltage of the battery pack 10 is low, since the power supply voltage VCC necessary for starting the control circuit 12 is supplied to the control circuit 12, the control circuit 12 can operate and can monitor the secondary battery 11. Further, for example, the control circuit 12 can more reliably detect the battery cell BC that is short-circuited and the battery cell BC whose cell state is the deep discharge state S0. As a result, in the battery pack 10, a state of the secondary battery 11 can be more reliably monitored.

Further, in the battery pack 10, the indicator 14 and the buzzer 15 capable of notifying the user of a result of monitoring by the control circuit 12 are provided. Therefore, for example, the user can perform the work efficiently. Further, for example, in a case where there is a problem with the battery pack 10, the user can know a state of the battery pack 10, and make a determination to stop the work. Therefore, the user who has only experience of rescuing a vehicle provided with a general auxiliary battery can perform work, so that the convenience of the user can be enhanced.

Further, in the battery pack 10, the diodes D1 to D3 are provided. The diode D1 has an anode connected to the charging terminal TC and a cathode connected to the power supply terminal TVCC of the control circuit 12. The diode D2 is provided in a current path connecting the positive terminal TP and the charging terminal TC, and has an anode guided to the charging terminal TC and a cathode guided to the positive terminal TP. The diode D3 has an anode connected to the positive terminal TP and a cathode connected to the power supply terminal TVCC of the control circuit 12.

In the battery pack 10, for example, since the diode D2 is provided, it is possible to prevent current from flowing from the charging terminal TC to the outside. Therefore, for example, in preliminary charging, it is possible to reduce discharge from the charging terminal TC due to reverse connection of a booster cable or a short circuit of a booster cable. Further, for example, it is possible to reduce discharge from the charging terminal TC to the outside and reverse charging due to voltage shortage of the charger 100 or the external battery. Further, for example, during normal use in the vehicle 1, it is possible to reduce discharge from the charging terminal TC due to oil, dust, a metal member, or the like in an engine room, and to reduce decrease in the power supply voltage VCC.

Further, since the diodes D1 and D3 are provided in the battery pack 10, for example, it is possible to supply the power supply voltage VCC to the control circuit 12 and prevent current from flowing from the charging terminal TC to the outside. By the above, for example, during normal use in the vehicle 1, it is possible to reduce discharge from the charging terminal TC due to oil, dust, or the like in an engine room, and to reduce decrease in the power supply voltage VCC.

Further, since the diode D3 is provided in the battery pack 10, for example, in a case where battery voltage of the secondary battery 11 is low, the diode D3 is in an off state by voltage supplied from the charger 100, so that the sufficient power supply voltage VCC can be applied to the control circuit 12. As a result, the control circuit 12 can be activated.

As described above, in the present embodiment, the secondary battery, the positive terminal and the negative terminal connected to the secondary battery, the control circuit having the power supply terminal and capable of monitoring the secondary battery, the charging terminal guided to the power supply terminal of the control circuit, and the resistive element provided in a current path connecting the positive terminal and the charging terminal are provided, so that a state of a rechargeable battery can be more reliably monitored.

In the present embodiment, since the indicator and the buzzer capable of notifying the user of a result of monitoring by the control circuit are provided, the convenience of the user can be enhanced.

In an embodiment, the resistive element R1 is provided, but the present technology is not limited thereto, and various elements capable of limiting current can be used. For example, a positive temperature coefficient (PTC) element, a tungsten element, a constant current diode, or the like can be used.

The PTC element is an element having a characteristic that an electric resistance value increases as a temperature increases. In the battery pack 10, for example, as charging of the secondary battery 11 progresses, a battery voltage increases, a voltage difference between both ends of the resistive element R1 decreases, and charging current decreases. In a case where the PTC element is used instead of the resistive element R1, as charging progresses, charging current decreases, and a calorific value of the PTC element decreases, so that an electric resistance value decreases. As a result, charging time of preliminary charging can be shortened as compared with the case of the resistive element R1. The same applies to an element containing tungsten. The tungsten element is an element containing tungsten, and is, for example, a filament of a light bulb.

The constant current diode is basically an element in which a current amount is substantially constant regardless of a voltage difference between both ends. In a case where the constant current diode is used instead of the resistive element R1, charging current is substantially constant when charging progresses, so that charging time of preliminary charging can be shortened.

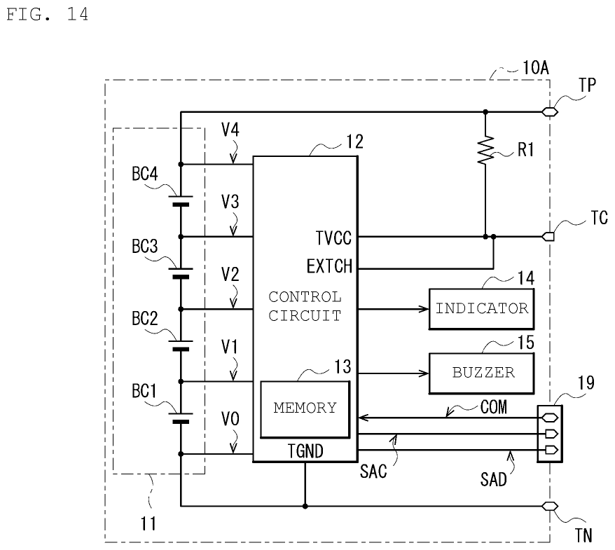

In an embodiment, the diodes D1 to D3 are provided as illustrated in FIG. 1, but the present technology is not limited thereto, and instead, for example, the diodes D1 to D3 do not need to be provided as in a battery pack 10A illustrated in FIG. 14. Even in this case, charging current is limited by the resistive element R1 in preliminary charging. Therefore, for example, in a case where battery voltage of the battery pack 10 is low, since the power supply voltage VCC necessary for starting the control circuit 12 is supplied to the control circuit 12, the control circuit 12 can operate and can monitor the secondary battery 11. Further, for example, the control circuit 12 can more reliably detect the battery cell BC that is short-circuited and the battery cell BC whose cell state is the deep discharge state S0. As a result, in the battery pack 10, a state of the secondary battery 11 can be more reliably monitored.

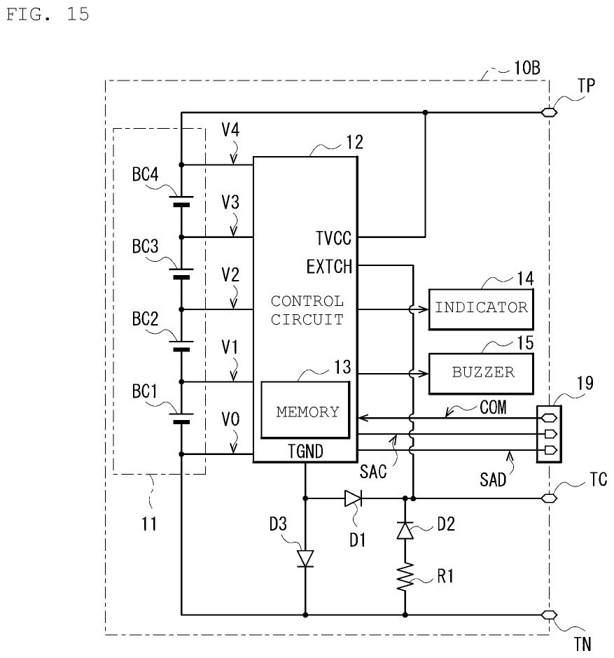

In an embodiment, a circuit including the diodes D1 to D3 and the resistive element R1 is connected to the positive terminal TP and the charging terminal TC, but the present technology is not limited thereto. Alternatively, for example, as in a battery pack 10B illustrated in FIG. 15, a circuit including the diodes D1 to D3 and the resistive element R1 may be connected to the negative terminal TN and the charging terminal TC. An anode of the diode D1 is connected to an anode of the diode D3 and the power supply terminal TGND of the control circuit 12, and a cathode is connected to the charging terminal TC of the battery pack 10B, a cathode of the diode D2, and the terminal EXTCH of the control circuit 12. An anode of the diode D2 is connected to the resistive element R1, and a cathode is connected to the charging terminal TC of the battery pack 10B, the cathode of the diode D1, and the terminal EXTCH of the control circuit 12. An anode of the diode D3 is connected to the anode of the diode D1 and the power supply terminal TGND of the control circuit 12, and a cathode is connected to a negative electrode of the battery cell BC1, the resistive element R1, and the negative terminal TN of the battery pack 10B. The power supply terminal TGND corresponds to a specific example of a “power supply terminal” in the present disclosure. In a case of performing preliminary charging on the battery pack 10B, the user inserts and connects the charger 100 between the positive terminal TP and the charging terminal TC of the battery pack 10B.

In an embodiment, preliminary charging is performed until a cell state of all of four of the battery cells BC1 to BC4 becomes the normal state S2, and after that, a booster cable is reconnected, and the engine 5 is started based on power of the charger 100 and the secondary battery 11 for which the preliminary charging is completed, but the present technology is not limited thereto. Alternatively, for example, charging may be continued after preliminary charging is completed, and then the engine 5 may be started based on power of a battery pack. Hereinafter, a battery pack 10C according to the present variation will be described in further detail according to an embodiment.

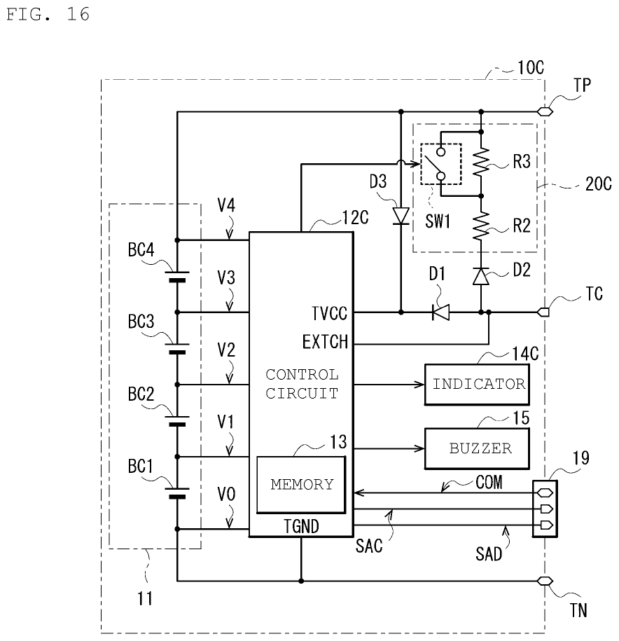

FIG. 16 illustrates a configuration example of the battery pack 10C. The battery pack 10C includes a control circuit 12C, resistive elements R2 and R3, a switch SW1, and an indicator 14C.

In the preliminary charging mode, the control circuit 12C detects a voltage applied to the charging terminal TC, and controls operation of the indicator 14C and the buzzer 15 based on the cell voltage VBC of each of the battery cells BC1 to BC4 and the voltage applied to the charging terminal TC. Further, the control circuit 12C controls operation of the switch SW1 based on a result of monitoring the cell voltage VBC. Specifically, the control circuit 12C sets the switch SW1 in an off state in the preliminary charging mode, and sets the switch SW1 in an on state in a case where the cell voltage VBC of all of the battery cells BC1 to BC4 becomes equal to or more than the discharge end voltage VC2.

One end of the resistive element R2 is connected to a cathode of the diode D2, and the other end is connected to one end of the resistive element R3 and one end of the switch SW1. One end of the resistive element R3 is connected to the other end of the resistive element R2 and one end of the switch SW1, and the other end is connected to the other end of the switch SW1, a positive electrode of the battery cell BC4, an anode of the diode D3, and the positive terminal TP.

The switch SW1 is turned on and off on the basis of an instruction from the control circuit 12C, has one end connected to the other end of the resistive element R2 and one end of the resistive element R3, and the other end connected to the other end of the resistive element R3, a positive electrode of the battery cell BC4, an anode of the diode D3, and the positive terminal TP. The switch SW1 is configured using, for example, a relay or a transistor.

The resistive elements R2 and R3 and the switch SW1 constitute a current limiting circuit 20C. The current limiting circuit 20C can reduce a resistance value between both ends of the current limiting circuit 20C as the switch SW1 becomes in an on state.

The indicator 14C includes four LEDs in this example. The four LEDs include an LED indicating unusability, an LED indicating unsuitability of a charger, an LED indicating completion of preliminary charging, and an LED indicating that an engine can be started. The LED indicating unusability, the LED indicating unsuitability of a charger, and the LED indicating completion of preliminary charging are similar to those in the above embodiment. The LED indicating that an engine can be started is configured to be turned on in a case where a battery voltage of the secondary battery 11 becomes a voltage at which the engine starter 4 can start the engine 5.

Next, an operation procedure of a provider (hereinafter, also referred to as the user) in a case of rescuing the vehicle 1 including the battery pack 10C illustrated in FIG. 16 will be described.

First, the user connects one end of a red booster cable to the charging terminal TC of the battery pack 10C mounted on the vehicle 1 (first operation).

Next, the user connects the other end of the red booster cable to a positive electrode of the charger 100 (second operation).

Next, the user connects one end of a black booster cable to a negative electrode of the charger 100 (third operation).

Next, the user connects the other end of the black booster cable to the engine 5 of the vehicle 1 (fourth operation). Note that the engine 5 is electrically connected to the negative terminal TN of the battery pack 10C. By the above, in the battery pack 10C, preliminary charging is started. In the battery pack 10C, the switch SW1 is in an off state. By the above, charging current flows to the secondary battery 11 via the charging terminal TC, the diode D2, the resistive element R2, and the resistive element R3.

Next, the user waits until the LED indicating completion of preliminary charging is turned on (fifth operation). In a case where the LED indicating unusability or the LED indicating unsuitability of a charger is turned on, the user immediately disconnects a booster cable or operates the charger 100, for example, to stop charging (sixth operation).

In a case where the LED indicating completion of preliminary charging is turned on, the user further waits until the LED indicating that an engine can be started is turned on (seventh operation). When preliminary charging is completed, the switch SW1 becomes in an on state. By the above, since the resistive element R3 of two of the resistive elements R2 and R3 connected in series is short-circuited, charging current flows to the secondary battery 11 via the charging terminal TC, the diode D2, the resistive element R2, and the switch SW1.

In a case where the LED indicating that an engine can be started is turned on, the user disconnects a booster cable (eighth operation).

Then, the user operates the vehicle 1 to start the engine 5 of the vehicle 1 (ninth operation). Specifically, for example, when the user presses an engine start switch (not illustrated), the ECU 2 instructs the engine starter 4 to start the engine 5. Then, the engine starter 4 starts the engine 5 based on power supplied from the battery pack 10.

The user can rescue the vehicle 1 including the battery pack 10C by performing such work.

As described above, in the battery pack 10C, since the switch SW1 is in an on state after preliminary charging is completed, the resistive element R3 of two of the resistive elements R2 and R3 connected in series is short-circuited, a resistance value is reduced, and as a result, charging current can be increased. By the above, in the battery pack 10C, charging time until battery voltage of the secondary battery 11 reaches a voltage at which the engine starter 4 can start the engine 5 can be shortened.

In this example, the LED indicating that an engine can be started is provided in the indicator 14C, but the present technology is not limited thereto, and instead, for example, the LED indicating that an engine can be started does not need to be provided. In this case, the user measures a battery voltage by using a tester, and in a case where the battery voltage reaches a voltage at which the engine starter 4 can start the engine 5, the user disconnects a booster cable (eighth operation) and starts the engine 5 of the vehicle 1 (ninth operation).

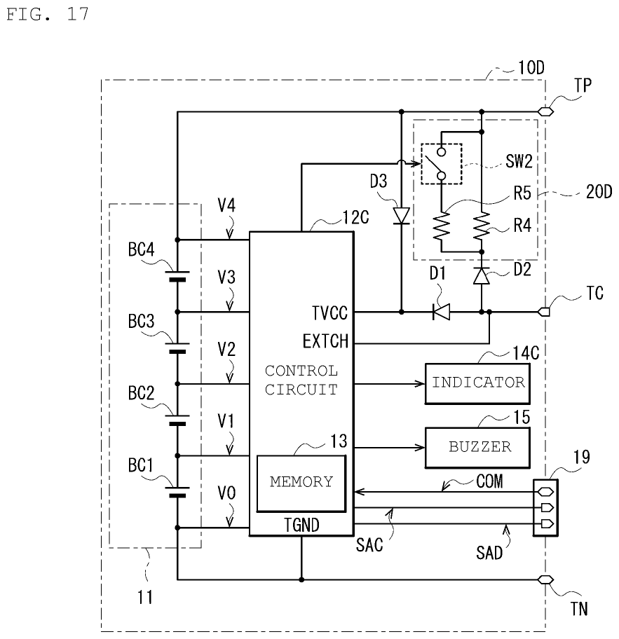

In this example, as illustrated in FIG. 16, a resistance value is reduced by short-circuiting the resistive element R3 of two of the resistive elements R2 and R3 connected in series, but the present technology is not limited thereto. Alternatively, for example, as in a battery pack 10D illustrated in FIG. 17, a resistance value may be reduced by connecting two resistive elements R4 and R5 in parallel.

One end of the resistive element R4 is connected to a cathode of the diode D2 and one end of the resistive element R5, and the other end is connected to a switch SW2, a positive electrode of the battery cell BC4, an anode of the diode D3, and the positive terminal TP. One end of the resistive element R5 is connected to a cathode of the diode D2 and one end of the resistive element R3, and the other end is connected to the switch SW2.

The switch SW2 is turned on and off on the basis of an instruction from the control circuit 12C, and has one end connected to the other end of the resistive element R5, and the other end connected to the other end of the resistive element R4, a positive electrode of the battery cell BC4, an anode of the diode D3, and the positive terminal TP.

The resistive elements R4 and R5 and the switch SW2 constitute a current limiting circuit 20D. The current limiting circuit 20D can reduce a resistance value between both ends of the current limiting circuit 20D as the switch SW2 becomes in an on state.

The control circuit 12C sets the switch SW2 in an off state in the preliminary charging mode, and sets the switch SW2 in an on state in a case where the cell voltage VBC of all of the battery cells BC1 to BC4 becomes equal to or more than the discharge end voltage VC2.

As described above, in the battery pack 10D, similarly to the battery pack 10C, since the switch SW2 is in an on state after preliminary charging is completed, two of the resistive elements R4 and R5 are connected in parallel, a resistance value is reduced, and charging current can be increased. By the above, in the battery pack 10D, charging time until battery voltage of the secondary battery 11 reaches a voltage at which the engine starter 4 can start the engine 5 can be shortened.

In the above-described embodiment and the like, in a case where the charger 100 is connected to the charging terminal TC, charging current flows from the charger 100 toward the secondary battery 11, but the present technology is not limited thereto, and, for example, a switch may be provided in a path through which charging current flows so that charging can be stopped. Hereinafter, a battery pack 10E according to the present variation will be described in detail.

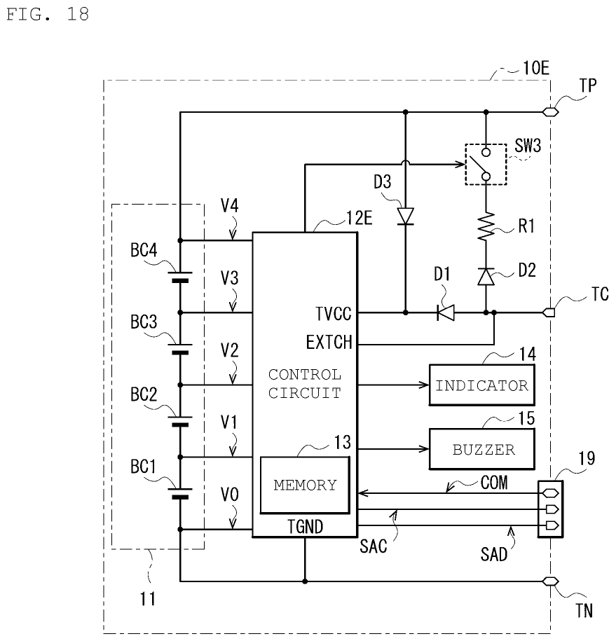

FIG. 18 illustrates a configuration example of the battery pack 10E. The battery pack 10E includes a control circuit 12E and a switch SW3.

In the preliminary charging mode, the control circuit 12E controls operation of the switch SW3 based on a result of monitoring the cell voltage VBC and voltage applied to the charging terminal TC. Specifically, for example, the control circuit 12E sets the switch SW3 in an off state in a case where the control circuit 12E is not started, and sets the switch SW3 in an on state at a timing of start. Further, for example, in a case where voltage applied to the charging terminal TC is not a voltage within a predetermined voltage range, the control circuit 12E sets the switch SW3 in an off state. Further, the control circuit 12E is configured to set the switch SW3 in an off state, for example, in a case where the cell voltage VBC of any one of the battery cells BC1 to BC4 is lower than the recharge prohibition voltage VC1 or is equal to or more than the charge end voltage VC3.

The switch SW3 is turned on and off based on an instruction from the control circuit 12E, and has one end connected to the other end of the resistive element R1, and the other end connected to a positive electrode of the battery cell BC4, an anode of the diode D3, and the positive terminal TP.

With this configuration, in the battery pack 10E, the switch SW3 is set in an off state in a period from when the charger 100 is connected to the charging terminal TC until the control circuit 12E is started. Further, in the battery pack 10E, for example, in a case where voltage supplied from the charger 100 is not appropriate, the switch SW3 is set in an off state. Further, in the battery pack 10E, in a case where a problem occurs in the secondary battery 11, the secondary battery 11 is not charged. Further, for example, in a case where the secondary battery 11 is sufficiently charged, the secondary battery 11 is not further charged.

Therefore, in the battery pack 10E, for example, in a case where the user does not notice a notification of the indicator 14 or the buzzer 15 in the preliminary charging mode, charging can be stopped.

In this example, an example in which the battery pack 10E is mounted on the vehicle 1 is described, but for example, in a case where the battery pack 10E is detached from the vehicle 1 and stored, a charger can be kept connected to the battery pack 10E. Even in this case, for example, in a case where a problem occurs in the secondary battery 11 or in a case where the secondary battery 11 is sufficiently charged, charging of the secondary battery 11 can be stopped. By the above, the battery pack 10E can be stored in a charged state.

Further, two or more of these variations may be combined according to an embodiment.

Next, an application example of the battery pack described herein will be described according to an embodiment. Hereinafter, an electric vehicle to which the battery pack is applied will be described according to an embodiment. A configuration of an electric vehicle below is an example, and thus can be appropriately changed.

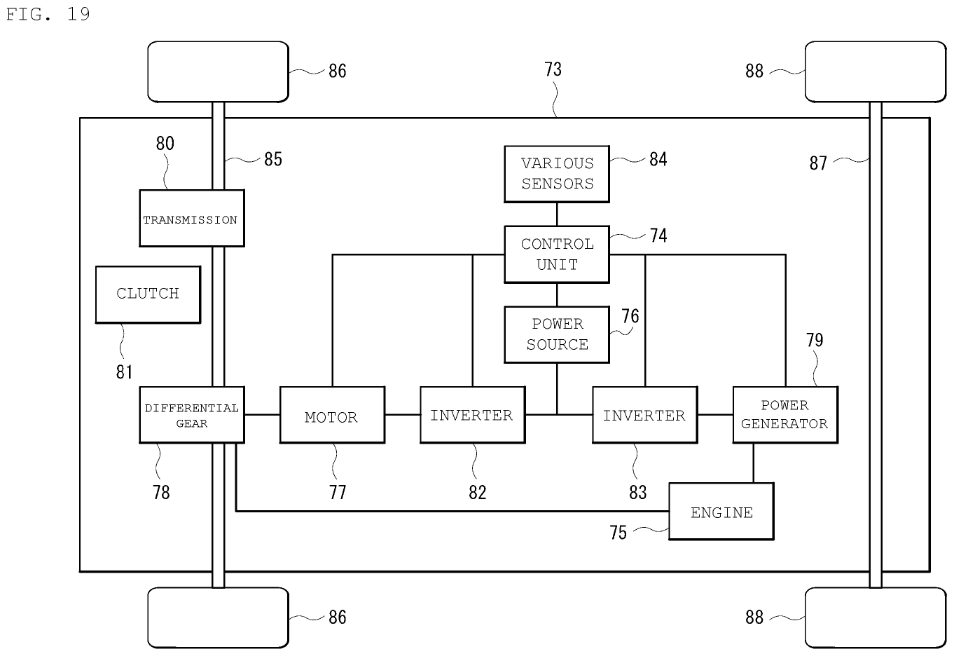

FIG. 19 illustrates a block configuration of a hybrid electric vehicle (HEV) which is an example of an electric vehicle. This HEV includes, for example, a control unit 74, an engine 75, a power supply 76, a driving motor 77, a differential gear 78, a power generator 79, a transmission 80 and a clutch 81, inverters 82 and 83, and various sensors 84 inside a vehicle body 73. In addition to these, the HEV includes, for example, a front wheel drive shaft 85 connected to the differential gear 78 and the transmission 80, a front wheel 86, a rear wheel drive shaft 87, and a rear wheel 88.

The HEV described here can be travel by using any one of the engine 75 and the motor 77 as a drive source, for example. The engine 75 is a main power source, and is, for example, a gasoline engine or the like. In a case of using the engine 75 as a power source, for example, a driving force (rotational force) of the engine 75 is transmitted to the front wheel 86 and the rear wheel 88 via the differential gear 78, the transmission 80, and the clutch 81 which are driving units. Note that, a rotational force of the engine 75 is transmitted to the power generator 79, thus the power generator 79 generates AC power utilizing the rotational force and the AC power is converted into DC power by the inverter 83, and the DC power is thus accumulated in the power supply 76. On the other hand, in a case of using the motor 77 which is a conversion unit as a power source, power (DC power) supplied from the power supply 76 is converted into AC power by the inverter 82, and thus the motor 77 is driven utilizing the AC power. A driving force (rotational force) converted from power by the motor 77 is transmitted to the front wheel 86 and the rear wheel 88, for example, via the differential gear 78, the transmission 80, and the clutch 81 which are driving units.

Note that when the HEV is decelerated by a brake mechanism, a resistance force at the time of deceleration is transmitted to the motor 77 as a rotational force, and thus the motor 77 may generate AC power by utilizing the rotational force. This AC power is converted into DC power by the inverter 82, and thus the DC regenerative power is preferably accumulated in the power supply 76.

The control unit 74 includes, for example, a central processing unit (CPU) and the like, and controls operation of the entire HEV. The power supply 76 includes one or two or more secondary batteries, and can be connected to an external power supply. The various sensors 84 include, for example, any one type of, or two or more types of a speed sensor, an acceleration sensor, an engine speed sensor, and the like, and are used to control a speed of the engine 75 and an opening degree of a throttle valve (throttle opening degree).

Note that, although the case where an electric vehicle is an HEV is described as an example, the electric vehicle may be a vehicle (electric vehicle) that operates using only the power supply 76 and the motor 77 without using the engine 75, a plug-in hybrid electric vehicle (PHEV) to which an external charging function is added, a hydrogen fuel cell vehicle (FCV), or another vehicle other than these.

The battery pack described herein can be applied to, for example, a secondary battery included in the power supply 76.

Although the present technique is described herein, the present technique is not limited thereto, and various modifications can be made according to an embodiment.

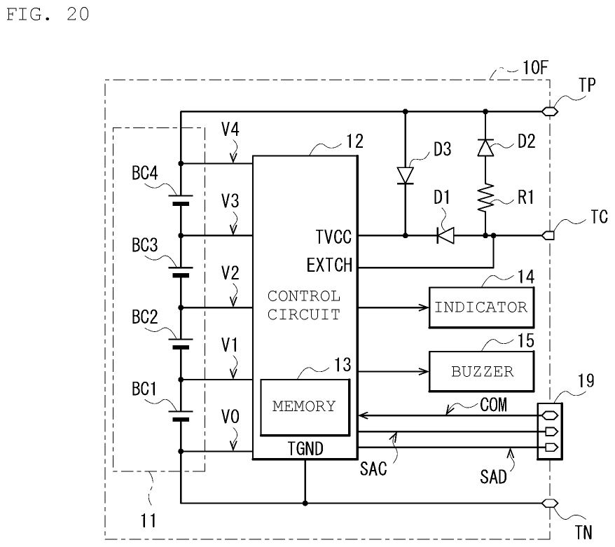

For example, the charging terminal TC, the diode D2, the resistive element R1, and the positive terminal TP are connected in this order as illustrated in FIG. 1, but the present technology is not limited thereto, and, for example, as in a battery pack 10F illustrated in FIG. 20, connection positions of the diode D2 and the resistive element R1 may be interchanged. In this case, an anode of the diode D2 is connected to the resistive element R1, and a cathode is connected to the positive terminal TP. One end of the resistive element R1 is connected to the charging terminal TC, and the other end is connected to the anode of the diode D2. Note that, in this example, the present variation is applied to the battery pack 10 illustrated in FIG. 1, but the present variation may be applied to the battery pack as further described herein according to an embodiment.

Note that the effect described herein is merely an example and is not limited, and any suitable effect may be provided.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a secondary battery;
a positive terminal and a negative terminal that are connected to the secondary battery;
a control circuit that includes a power supply terminal and is capable of monitoring the secondary battery;
a charging terminal guided to the power supply terminal of the control circuit; and
a current limiting element provided in a current path connecting a first terminal, which is one of the positive terminal and the negative terminal, and the charging terminal.

2. The battery pack according to claim 1, wherein
the secondary battery includes a plurality of battery cells, and
the control circuit is capable of monitoring a voltage of each of the plurality of battery cells.

3. The battery pack according to claim 2, further comprising a notification unit capable of notifying a user of a result of monitoring by the control circuit.

4. The battery pack according to claim 3, wherein
the control circuit is capable of performing first detection operation of detecting that a cell voltage of each of the plurality of battery cells is equal to or more than a predetermined voltage, and
the notification unit is capable of notifying a result of the first detection operation.

5. The battery pack according to claim 3, wherein
the control circuit is capable of performing second detection operation of detecting whether or not the secondary battery is unusable based on a cell voltage of each of the plurality of battery cells, and
the notification unit is capable of notifying a result of the second detection operation.

6. The battery pack according to claim 1, wherein the current limiting element includes any one of a resistive element, a PTC element, a tungsten element, and a constant current diode.

7. The battery pack according to claim 1, further comprising
a first diode having an anode connected to the charging terminal and a cathode connected to the power supply terminal of the control circuit, wherein
the first terminal is the positive terminal.

8. The battery pack according to claim 7, further comprising:
a second diode provided in the current path and having an anode guided to the charging terminal and a cathode guided to the first terminal; and
a third diode having an anode connected to the first terminal and a cathode connected to the power supply terminal of the control circuit.

9. The battery pack according to claim 1, further comprising
a first diode having an anode connected to the power supply terminal of the control circuit and a cathode connected to the charging terminal, wherein
the first terminal is the negative terminal.

10. The battery pack according to claim 9, further comprising:
a second diode provided in the current path and having an anode guided to the first terminal and a cathode guided to the charging terminal; and
a third diode having an anode connected to the power supply terminal of the control circuit and a cathode connected to the first terminal.

11. The battery pack according to claim 1, further comprising
a current limiting circuit provided in the current path and including the current limiting element and a switch, wherein
the current limiting circuit is capable of decreasing a resistance value between both ends of the current limiting circuit in the current path when the switch is set in an on state, and
the control circuit is capable of setting the switch in an on state based on a result of monitoring the secondary battery.

12. The battery pack according to claim 1, further comprising
a switch provided in the current path, wherein
the control circuit is capable of setting the switch in an off state based on a result of monitoring the secondary battery.

13. The battery pack according to claim 1, wherein the secondary battery includes a lithium ion secondary battery.

14. A vehicle comprising:
a driving force generation unit capable of generating a driving force;
a drive control unit capable of controlling operation of the driving force generation unit; and
a battery pack capable of supplying power to the drive control unit, wherein
the battery pack includes:
a secondary battery;
a positive terminal and a negative terminal that are connected to the secondary battery;
a control circuit that includes a power supply terminal and is capable of monitoring the secondary battery;
a charging terminal guided to the power supply terminal of the control circuit; and
a current limiting element provided in a current path connecting a first terminal, which is one of the positive terminal and the negative terminal, and the charging terminal.
